(19) United States
(12) Patent Application Publication
(10) Pub. No.: US 2009/0070207 A1
(43) Pub. Date: Mar. 12, 2009

(54) Electronic coupon display system and method

(75) Inventors: Blake Engel, San Francisco, CA (US); Ish Harshawat, San Francisco, CA (US)

Correspondence Address: NIXON PEABODY, LLP, 401 9TH STREET, NW, SUITE 900, WASHINGTON, DC, 20004-2128, US

(73) Assignee: CELLFIRE, San Jose, CA (US)

(21) Appl. No.: 11/898,197

(22) Filed: Sep. 10, 2007

(51) Int. Cl. G06Q 30/00; G06F 15/16; G06F 3/048

(52) U.S. Cl. 705/14; 715/810

(57) ABSTRACT

Electronic coupons are downloaded from a coupon server to a multifunction device and the coupons are stored on the multifunction device. Each electronic coupon includes a text-based form of the coupon and an image-based form of the coupon that includes promotional offers and/or brand indicia. When a consumer hovers a selection cursor over a text-based form of the electronic coupon currently shown on the display of the multifunction device, the text-based form of the coupon is replaced on the display with the corresponding image-based form of the coupon, including promotional offers and/or brand indicia, for the duration of the hover condition. This replacement operation maximizes the marketing value of an electronic coupon while minimizing the marketing impact to other electronic coupons on the same multifunction device display.

### BACKGROUND

In recent years, cellular telephones have evolved from simple, dedicated devices for making voice telephone calls to sophisticated, multifunction devices for communicating voice and data. As part of this evolution, the computing power of such devices has increased dramatically, allowing complex application programs to be written for these devices. Additionally, the input capabilities of these multifunction devices have become far more flexible, often allowing users to interact with multifunction devices by way of keys, touchscreens and/or small keyboards. These concurrent improvements in communications capabilities, computing power, and user input flexibility have allowed a new generation of rich, interactive applications to develop for mobile communication devices.

A primary example of such rich, interactive applications is one which downloads electronic coupons from a coupon server to a multifunction device, for possible redemption at a retail store. For example, such applications are disclosed in United States Published Patent Application 20060190331 entitled Delivering targeted advertising to mobile devices and United States Published Patent Application 20060190330 entitled Delivering targeted advertising to mobile devices. The disclosures of both of these applications are incorporated herein by reference.

Prior to redemption of a coupon, the multifunction device may have a series of coupons stored in memory, available for selection by a consumer. When the consumer selects a coupon stored in memory, an interactive coupon application executing on the multifunction device communicates the selection to a server. Upon receiving the selection, the server validates the selected coupon and responds to the coupon application with a message that enables redemption of the selected coupon.

The rich nature of this coupon application is further supported by an ability to tailor coupon marketing and validation to individual consumers on several levels. Initially, targeted coupons may be sent to individual consumers based on their past purchase history or known brand preferences. Once a stored coupon is selected by a consumer for redemption, the coupon server may validate that the attempted coupon redemption meets certain characteristics before enabling redemption of the coupon. For example, the coupon server may verify that the date of attempted coupon redemption is within the date range of the corresponding promotion or that this consumer has not previously redeemed a similar coupon. Additionally, coupon redemption data may be collected and analyzed on a per-consumer and per-transaction basis. This analysis may highlight important purchasing trends among consumers (e.g., how many consumers that dine at a particular restaurant also shop at a nearby department store as part of the same trip). From these trends, coupons for related products may be sent to consumers, further enhancing the marketing value of the coupon application. Collecting and analyzing the sophisticated purchasing information that results from this interaction with consumers has tremendous value to retailers.

Despite the value such rich applications offer to retailers and to consumers, limitations in the multifunction devices have prevented these applications from reaching their full potential. Specifically, increases in the form factor of multifunction devices have not kept pace with the aforementioned improvements in these devices. Although the market has experimented with larger multifunction devices, consumers prefer devices that easily fit in the human hand. This consumer preference places an upper limit on the screen size in such devices, which limits the number of electronic coupons and the type of coupon information that may be displayed on such screens.

Limiting the number of electronic coupons that may be displayed on multifunction devices has negative consequences for the effective marketing of products related to such coupons. For example, if a coupon server sends a certain number of electronic coupons to a multifunction device, but less than that number of electronic coupons may be concurrently displayed on the multifunction device, the consumer may be required to interact with the device (e.g., pressing a scroll button) to see the additional electronic coupons. Unfortunately for the consumer and for the retailer, electronic coupons that require consumer interaction to display are often overlooked by consumers, substantially limiting the value of delivering such additional electronic coupons.

Limiting the type of coupon information that may be displayed on multifunction devices also has negative consequences for the effective marketing of products. Retailers invest heavily in brand identification, often through brand indicia, and they prefer to leverage this investment at every marketing opportunity. Additionally, consumers are often influenced by the presence of such brand indicia, as a means for quickly finding what they desire. Therefore, relying on a text-based electronic coupon rather than an image-based coupon with brand indicia may substantially reduce the marketing value of the electronic coupon to the retailer and to the consumer. However, images with brand indicia typically require more screen area than displaying textual representations of brand names. Thus, distributors of electronic coupons are faced with the difficult prospect of either limiting the number of coupons displayed or limiting the effectiveness of such coupons, or both, based on the limited screen size of the multifunction device.

What is needed in the art is a means for mitigating the aforementioned disadvantages.

### SUMMARY

In accordance with the present invention, embodiments of a communication application are presented. The communication application according to embodiments of the present invention can include a server module executable on a server computing device and a communication module executable on a communication device. The communication device may be a mobile telephone, a pager or a handheld computer and may include a display. The server module may be communicatively coupled over a network to the communication module.

In some embodiments of the invention, the communication module may include a coupon display module for storing a plurality of sets of coupon text data and respective brand indicia images corresponding to the sets of coupon text data. The coupon display module also sends plural sets of coupon text data to a client module. Each set of coupon text data corresponds to a coupon. The client module may display coupon text data on the communication device display without displaying brand indicia images. Additionally, the client module may replace a selected set of the coupon text data display with the respective brand indicia image corresponding to the selected set of coupon text data.

In some embodiments of the invention, the replacement operation may be performed when a cursor hovers over the coupon text data via a user interface, as a means for selecting one set of coupon text data corresponding to a desired coupon.

In some embodiments of the invention, the server module is coupled to a coupon repository that is capable of storing a plurality of sets of coupon text data and corresponding brand indicia images. Additionally, the server module may include an operation of sending plural sets of coupon text data to the client module.

### BRIEF DESCRIPTION OF THE DRAWING

FIGS. 1A, 1B and 1C illustrate a system in which embodiments of the present invention may be practiced; and

FIGS. 2A, 2B and 2C illustrate display screens on a multifunction device display demonstrating embodiments of the present invention.

### DETAILED DESCRIPTION

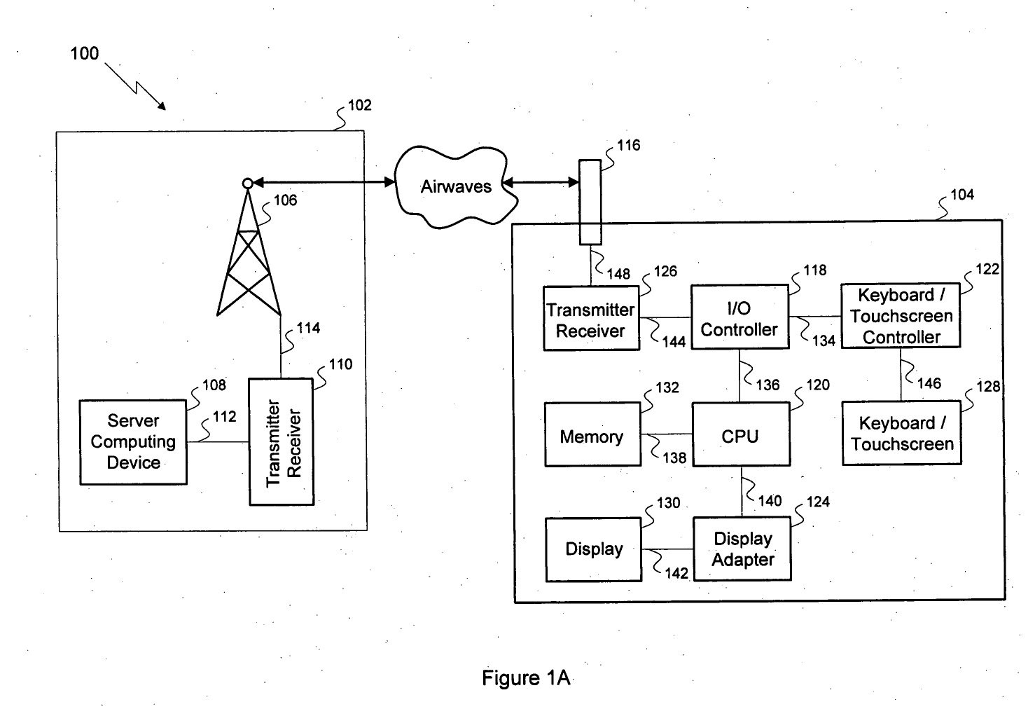

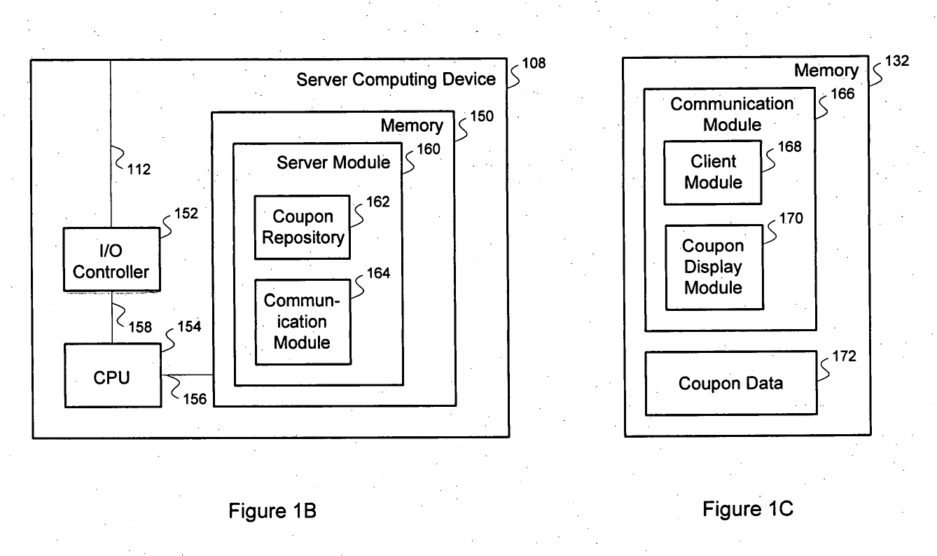

FIGS. 1A, 1B and 1C illustrate a system 100 in which embodiments of the present invention may be practiced. As shown in FIG. 1A, the system 100 includes a base station 102 and a handheld multifunction device 104. The multifunction device 104 may be a mobile telephone, handheld computer, or a pager. The base station 102 includes a server computing device 108, a server transmitter/receiver 110 and a server antenna 106. Base station 102 may be incorporated into a cellular phone network or other wireless phone network. For example, communications between base station 102 and multifunction device 104 can be over the internet or other wireless network.

Within the base station 102, the transmitter/receiver 110 translates voice and digital data, including electronic coupons, between a digital form that the server computing device 108 may utilize and a form that may be transmitted or received by the antenna 106. The transmitter/receiver 110 is coupled to the server computing device 108 and to the server antenna 106 through couplings 112 and 114, respectively. The cellular base station 102 may also be coupled to a conventional telephone network (not shown) and/or to other computer networks, including the Internet (not shown).

The multifunction device 104 includes an antenna 116, a central processing unit (“CPU”) 120, a memory 132, an input/output (“I/O”) controller 118, a transmitter/receiver 126, a keyboard/touchscreen controller 122, a display adapter 124, a display 130 and a keyboard/touchscreen 128. The CPU 120 executes machine instructions stored in the memory 132, including a communication module, that enable the multifunction device 104 to transmit and receive voice and data communications between the cellular base station 102 and the multifunction device 104. The CPU 120 also executes machine instructions which allow the multifunction device 104 to respond to user input, such as moving a selection cursor in response to user input received through the keyboard/touchscreen 128. The CPU 120 may update the display 130 in response to such user input. Display updates may include hovering the selection cursor over an electronic coupon shown on the display 130 or expanding a coupon from a text-based coupon to an image-based coupon.

The CPU 120 may also transmit or receive data from the cellular base station 102 by communicating with the I/O controller 118, which communicates with the transmitter/receiver 126. The transmitter/receiver 126 translates voice and digital data, including electronic coupons and the communication module, between a digital form that the I/O controller 118 may utilize and a form that may be transmitted or received by the antenna 116.

The I/O controller 118 is coupled to the transmitter/receiver 126, the keyboard/touchscreen controller 122 and the CPU 120 through couplings 144, 134 and 136, respectively. The CPU 120 is coupled to the memory 132 and the display adapter 124 through couplings 138 and 140, respectively. The display 130 is coupled to the display adapter 124 through a coupling 142. The keyboard/touchscreen controller 122 is coupled to the keyboard/touchscreen 128 through a coupling 146. The cellular base station 102 may communicate with the multifunction device 104 through antennas 106 and 116 as shown.

As shown in FIG. 1B, the server computing device 108 includes a CPU 154, an I/O controller 152 and a memory 150. The memory 150 includes a server module 160, which includes a coupon repository 162 and a communication module 164. The CPU 154 is coupled to the I/O controller 152 and to the memory 150 through couplings 158 and 156, respectively. The server computing device 108 communicates with the transmitter/receiver 110 through I/O controller 152 and through coupling 112, as previously described. The CPU 154 executes instructions stored in memory 150. Of course, memory 150 can include nonvolatile memory, such as a magnetic or optical disk and volatile memory, such as processor RAM. As shown in FIG. 1C, the memory 132 includes coupon data 172 and a communication module 166. The communication module 166 includes a client module 168 and a coupon display module 170. The CPU 120 executes instructions stored in memory 132. Of course, memory 132 can include nonvolatile memory, such as a magnetic or optical disk or flash memory, and volatile memory, such as processor RAM.

In one embodiment of the invention, the server computing device 108 acts as a communication application server by executing the server module 160. One function of the server module 160 is to transmit a copy of the communication module 164 to the multifunction device 104. Once the copy of the communication module 164 is received by the multifunction device 104, the CPU 120 stores the copy of the communication module 164 in memory 132 as communication module 166 and configures the communication module 166 for execution on the multifunction device 104.

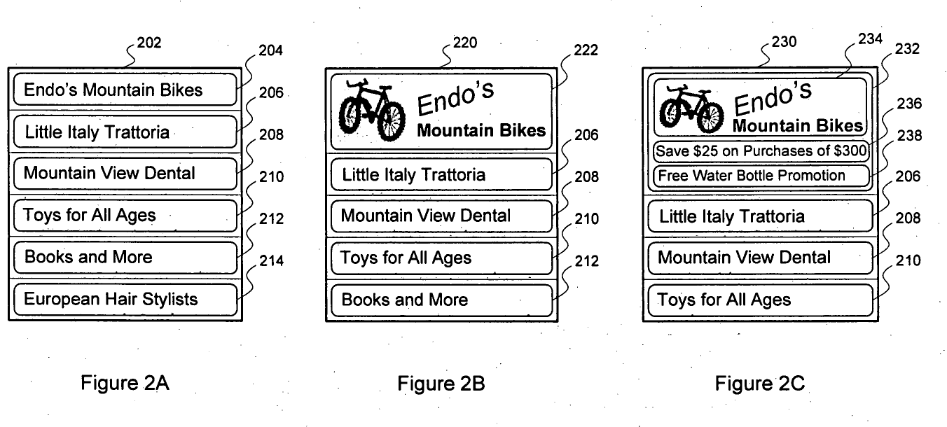

Another function of the server module 160 is to respond to coupon requests from the multifunction device 104. When the CPU 120 executes the communication module 166, the client module 168, as a communication application client, requests electronic coupons from the server module 160. In response, the server module 160 transmits a plurality of text-based electronic coupons with respective promotional offers and/or brand indicia images from the coupon repository 162 to the client module 168. The client module 168 stores the coupons received in coupon data 172 and also communicates the stored coupons to the coupon display module 170. Upon receiving the coupons, the coupon display module 170 displays the electronic coupons on the display 130, as described in conjunction with FIGS. 2A, 2B and 2C.

FIGS. 2A, 2B and 2C illustrate display screens 202, 220 and 230 on the multifunction device display 130 demonstrating an embodiment of the present invention. As shown in FIG. 2A, the display screen 202 includes a plurality of text-based electronic coupons, including a coupon 204 for “Endo's Mountain Bikes,” a coupon 206 for “Little Italy Trattoria,” a coupon 208 for “Mountain View Dental,” a coupon 210 for “Toys for All Ages,” a coupon 212 for “Books and More,” and a coupon 214 for “European Hair Stylists.” In other embodiments of the invention, any technically feasible number and style of text-based electronic coupons may be displayed on the display screen. The display screen 202 is configured to show a large number of electronic coupons to a consumer by limiting each coupon to a text-based representation that minimizes display space requirements. Additionally, the multifunction device 104 is configured to show display screen 202 when the user has not directed the selection cursor to hover over any of the electronic coupons.

As shown in FIG. 2B, the display screen 220 includes an image-based electronic coupon 222 for “Endo's Mountain Bikes,” in addition to a plurality of text-based electronic coupons 206, 208, 210 and 212. Importantly, the image-based electronic coupon 222 includes brand indicia which may be more valuable to consumers and to retailers than text-based electronic coupons. Again, the display of brand indicia within an image-based electronic coupon may allow consumers to more readily identify what they desire within the available electronic coupons and may also allow retailers to leverage existing investments in their brands to maximize sales.

In the present invention, the disadvantages related to displaying image-based coupons in prior art systems are substantially reduced by replacing a single text-based electronic coupon with a single image-based electronic coupon including brand indicia when a consumer causes the selection cursor to hover over the text-based electronic coupon. Upon recognizing such a hover condition, the CPU 120, in conjunction with the client coupons 168 and with the display adapter 124, replaces the text-based coupon (e.g., coupon 204) with the corresponding image-based coupon containing brand indicia (e.g., coupon 222) for the duration of the hover condition. In light of the limited display space available on the display 130, the CPU 120 may also intelligently shift the remaining text-based coupons down or up, including shifting one or more electronic coupons off the display 130, for the duration of the hover condition. Once an image-based coupon has been displayed, due to a hover condition, the user may select that coupon for redemption through interaction with the keyboard/touchscreen 128.

Additionally, if a consumer hovers over a sequence of text-based coupons, each text-based coupon is replaced with a corresponding image-based coupon including brand indicia for the duration of time that the selection cursor hovers over a corresponding coupon. Thus, the replacement operation allows image-based electronic coupons that include brand indicia to be displayed for each electronic coupon, while limiting the display area penalty for display of such coupons to the area penalty corresponding to a single image-based coupon. Limiting the area penalty for displaying a series of image-based coupons to the area penalty corresponding to a single image-based coupon represents a substantial improvement over prior art electronic coupon systems that incurred the area penalty for display of each image-based coupon.

As shown in FIG. 2C, the display screen 230 includes an image-based electronic coupon 232 for “Endo's Mountain Bikes,” in addition to a plurality of text-based electronic coupons 206, 208 and 210. Importantly, electronic coupon 232 includes a brand indicia 234 and a plurality of promotional offers 236 and 238. The display of promotional offers in conjunction with brand indicia may provide further marketing value to consumers and retailers, allowing better communication of purchasing opportunities than can be provided by text-based electronic coupons or by image-based electronic coupons that include brand indicia alone.

As described in conjunction with FIG. 2B, text-based electronic coupons may be replaced with image-based electronic coupons that include brand indicia and promotional offers when a user hovers the selection cursor over a text-based electronic coupon. Additionally, text-based electronic coupons may be temporarily shifted up/down or off the display screen to accommodate the larger size of an imaged-based electronic coupon with brand indicia and promotional offers. By replacing text-based electronic coupons with image-based electronic coupons that include brand indicia and promotional offers for the duration of the hover condition, a retailer may substantially improve the marketing value of electronic coupons without incurring the substantial disadvantages of a plurality of image-based electronic coupons, as described earlier. Including promotional offers in the image-based electronic coupons may also represent a marketing improvement over the image-based electronic coupons that include merely brand indicia, as described with regard to FIG. 2B.

One advantage of the disclosed system is that downloading electronic coupons with promotional offers and/or with brand indicia that are displayed during a hover condition offers substantial marketing value to retailers and consumers over prior art systems that employ purely text-based electronic coupons and over those prior art systems employing a plurality of image-based electronic coupons.

The various elements of the preferred embodiment can be implemented as hardware and/or software in various ways. For example, each module can be accomplished by a microprocessor programmed in a known manner. The server and multifunction device can be implemented as one or more devices communicating over a network or through local communications. For example, the “server can be one or more computing devices such as personal computers or servers. The various memories can be implemented as a single memory or plural memories as needed. Any type of operation systems and interfaces can be used to implement the invention.

What is claimed is:

1. A communication module for a handheld device having a display, said communication module comprising:
a client module executable on a communication device, for displaying items on the display; and
a coupon display module coupled to a memory storing a plurality of sets of coupon text data and respective brand indicia images corresponding to the sets of coupon text data, the coupon display module being operative to send plural sets of coupon text data to the client module for display without displaying brand indicia images, the client module including an operation for replacing only a selected set of the coupon text data with the respective brand indicia image to cause the brand indicia image corresponding to the selected set of coupon text data to be displayed on the display screen area with the other sets of coupon text data.

2. The communication module of claim 1, wherein the communication device is one of a mobile telephone, a pager and a handheld computer.

3. The communication module of claim 1, wherein the set of coupon text data is selected by causing a cursor to hover over the text data via a user interface

4. A communication module for a handheld device having a display, comprising:
means for causing display of plural sets of coupon text data, each set of coupon text data corresponding to a coupon;
means for selecting one set of coupon text data corresponding to a desired coupon; and
means for replacing display of only the selected set of the coupon text data with the respective brand indicia image to cause the brand indicia image corresponding to the selected set of coupon text data to be displayed on the display screen area with the other sets of coupon text data.

5. The communication module of claim 4, wherein the communication device is one of a mobile telephone, a pager and a handheld computer.

6. The communication module of claim 4, wherein the means for selecting comprises means for causing a cursor to hover over the text data via a user interface

7. A communication application executable on a network, comprising:
a communication module executable on a processor of a communication device, the communication device including a display screen for displaying items;
a server module executable on a processor communicatively coupled over the network to the communication module; and
a coupon repository coupled to the server module capable of storing a plurality of sets of coupon text data and corresponding brand indicia images;
wherein the server module includes an operation of sending plural sets of coupon text data to the communication module without displaying brand indicia, and the client module includes an operation for replacing only a selected set of the coupon text data displayed by the communication module with the respective brand indicia image to cause the brand indicia image corresponding to the selected set of coupon text data to be displayed on the display screen area with the other sets of coupon text data.

8. The communication application of claim 7, wherein the communication device is one of a mobile telephone, a pager and a handheld computer.

9. The communication application of claim 7, wherein the means for selecting comprises means for causing a cursor to hover over the text data via a user interface

10. A computer-readable media having computer readable instructions stored thereon, the instructions comprising:
instructions for causing display of plural sets of coupon text data, each set of coupon text data corresponding to a coupon;
instructions for selecting one set of coupon text data corresponding to a desired coupon; and
instructions for replacing display of only the selected set of the coupon text data with the respective brand indicia image to cause the brand indicia image corresponding to the selected set of coupon text data to be displayed on the display screen area with the other sets of coupon text data.

11. The computer readable media of claim 10 wherein the instructions for selecting comprises instructions for causing a cursor to hover over the text data via a user interface

12. A method of displaying electronic coupons on the display of a handheld device, the method comprising:
displaying plural sets of coupon text data, each set of coupon text data corresponding to a coupon;
selecting one set of coupon text data corresponding to a desired coupon; and
replacing display of only the selected set of the coupon text data with the respective brand indicia image to cause the brand indicia image corresponding to the selected set of coupon text data to be displayed on the display screen area with the other sets of coupon text data.

13. The method as recited in claim 12, wherein said step of selecting comprises using a user interface to cause a cursor to hover over the text data via a user interface.

14. The communication module of claim 1, wherein the branding indicia is a logo image corresponding to the coupon vendor.

15. The communication module of claim 4, wherein the branding indicia is a logo image corresponding to the coupon vendor.

16. The communication application of claim 7, wherein the branding indicia is a logo image corresponding to the coupon vendor.

17. The computer readable media of claim 10, wherein the branding indicia is a logo image corresponding to the coupon vendor.

18. The method of claim 12, wherein the branding indicia is a logo image corresponding to the coupon vendor.
